(19) United States
(12) Patent Application Publication
(10) Pub. No.: US 2014/0029553 A1
(43) Pub. Date: Jan. 30, 2014

(54) METHOD FOR UPLINK ACCESS AND TERMINAL DEVICE

(71) Applicant: HUAWEI TECHNOLOGIES CO., LTD., Shenzhen (CN)

(72) Inventors: Bingzhao LI, Beijing (CN); Yongqiang Gao, Beijing (CN); Yanyan Chen, Beijing (CN); Kun Yan, Shenzhen (CN)

(73) Assignee: HUAWEI TECHNOLOGIES CO., LTD., Shenzhen (CN)

(21) Appl. No.: 14/043,085

(22) Filed: Oct. 1, 2013

Related U.S. Application Data
(63) Continuation of application No. PCT/CN2012/073485, filed on Apr. 1, 2012.

(30) Foreign Application Priority Data
Apr. 2, 2011 (CN) 201110083709.9

(51) Int. Cl. H04W 36/22

(52) U.S. Cl. CPC H04W 36/22
USPC 370/329

(57) ABSTRACT

Embodiments of the present invention provide a method for uplink access and a terminal device. The method includes: obtaining load information of multiple cells, where the load information is interference level values of the multiple cells or comparison relationship values of the interference level values; and determining, according to the load information of the multiple cells, an uplink access carrier to be used for uplink access. According to the embodiments of the present invention, when a terminal device initiates uplink access actively, the terminal device can select a proper uplink access carrier according to load information such as the interference level values of cells or comparison relationship values of the interference level values.

### CROSS-REFERENCE TO RELATED APPLICATIONS

This application is a continuation of International Application No. PCT/CN2012/073485, filed on Apr. 1, 2012, which claims priority to Chinese Patent Application No. 201110083709.9, filed on Apr. 2, 2011, both of which are hereby incorporated by reference in their entireties.

### TECHNICAL FIELD

Embodiments of the present invention relate to the field of wireless communications, and in particular, to a method for uplink access and a terminal device.

### BACKGROUND

A multicarrier technology is a technology that uses multiple carriers simultaneously to transmit data to a terminal device (such as a UE, User Equipment, user equipment). It is widely applied to WCDMA (Wideband Code Division Multiple Access, Wideband Code Division Multiple Access), CDMA2000 (Code Division Multiple Access 2000, Code Division Multiple Access 2000), and LTE (Long Term Evolution, Long Term Evolution) system. A UE that works in multicarrier mode keeps communication with multiple carriers simultaneously, where each carrier may use multiple cells as macro diversity cells.

For example, in a multicarrier WCDMA system, a UE works with WCDMA cells of multiple carriers at the same time, which greatly increases downlink and uplink data transmission rates of the same UE. In addition, with the interoperations of multiple carriers, quick dynamic load balancing between multicarrier cells becomes possible. Such quick dynamic load balancing can increase the throughput rate of the original WCDMA cells and the timeliness of response to users. Currently, however, the multicarrier technology is only applied to UEs in a Cell_DCH (Cell Dedicated Channel, cell dedicated channel) state and UEs in a Cell_FACH (Cell Forward Access Channel, cell forward access channel) state cannot enjoy the gain brought by multiple carriers. There are already technologies that introduce the multicarrier technology for UEs in the Cell_FACH state. However, it is possible that a CELL_FACH UE which supports multicarrier transmission in the downlink supports only single-carrier transmission in the uplink. Because the cell selection of a Cell_FACH UE is based on the UE, a network cannot control which cell the UE will camp on. If all UEs initiate uplink transmission in the camped cell, uplink loads may possibly be over-concentrated.

When the network requires the UE to initiate uplink access, the network may indicate through physical layer signaling to the UE on which carrier the uplink access should be performed. However, this manner can only address the control of access carriers when the network triggers uplink access of the UE, but cannot address the control of carriers when the UE triggers uplink access actively.

### SUMMARY

Embodiments of the present invention provide a method for uplink access and a terminal device, which can solve the issue of carrier selection for uplink access.

In one aspect, a method for uplink access is provided, including: obtaining load information of multiple cells, where the load information is interference level values of the multiple cells or comparison relationship values of the interference level values; and determining, according to the load information of the multiple cells, an uplink access carrier to be used for uplink access.

In another aspect, a terminal device is provided, including: an obtaining unit, configured to obtain load information of multiple cells, where the load information is interference level values of the multiple cells or comparison relationship values of the interference level values; and a determining unit, configured to determine, according to the load information of the multiple cells, an uplink access carrier to be used for uplink access.

In this way, according to the embodiment of the present invention, when a terminal device initiates uplink access actively, the terminal device can select a proper uplink access carrier according to load information such as interference level values of cells or comparison relationship values of the interference level values, which solves the issue of carrier selection when a terminal triggers uplink access actively.

In another aspect, a method for uplink access is provided, including: obtaining a terminal identifier and the quantity of available uplink access carriers; determining, according to the terminal identifier and the quantity of available uplink access carriers, an uplink access carrier to be used for uplink access; and performing uplink access by using the uplink access carrier.

In another aspect, a terminal device is provided, including: an obtaining unit, configured to obtain a terminal identifier and the quantity of available uplink access carriers; a determining unit, configured to determine, according to the terminal identifier and the quantity of available uplink access carriers, an uplink access carrier to be used for uplink access; and an access unit, configured to execute uplink access by using the uplink access carrier.

In this way, in the embodiment of the present invention, a terminal device can select an uplink access carrier to be used for uplink access from available uplink access carriers according to a terminal identifier and the quantity of the available uplink access carriers, which solves the issue of carrier selection when a terminal triggers uplink access actively.

In another aspect, a method for allocating terminal identifiers to a terminal device is provided, where the terminal device is capable of selecting an uplink access carrier from multiple carriers including a primary carrier and secondary carriers and the method includes: allocating, by a base station, a terminal identifier corresponding to the primary carrier to the terminal device; and allocating, by a radio network controller, terminal identifiers corresponding to the secondary carriers to the terminal device.

In another aspect, a network device for allocating terminal identifiers to a terminal device is provided, where the terminal device is capable of selecting an uplink access carrier from multiple carriers including a primary carrier and secondary carriers and the network device includes a base station and a radio network controller, where the base station is configured to allocate a terminal identifier corresponding to the primary carrier to the terminal device; and the radio network controller is configured to allocate terminal identifiers corresponding to the secondary carriers to the terminal device.

In this way, in the embodiment of the present invention, not only a base station is used to allocate a terminal identifier but also a radio network controller is allowed to allocate terminal identifiers corresponding to secondary carriers, which speeds up allocation of terminal identifiers.

In another aspect, a method for broadcasting common enhanced dedicated channel resource information of multiple cells is provided, including: carrying corresponding common enhanced dedicated channel resource information in system information blocks of the multiple cells; setting scheduling time of the system information blocks carrying the common enhanced dedicated channel resource information of the multiple cells to the same; and broadcasting the system information blocks.

In another aspect, a network device for broadcasting common enhanced dedicated channel resource information of multiple cells is provided, including: a generating unit, configured to carry corresponding common enhanced dedicated channel resource information in system information blocks of the multiple cells; a setting unit, configured to set scheduling time of the system information blocks carrying the common enhanced dedicated channel resource information of the multiple cells to the same; and a broadcasting unit, configured to broadcast the system information blocks.

In this way, in the embodiment of the present invention, system information blocks of multiple cells have the same scheduling time and therefore the scheduling of the system information blocks can be aligned, so that a terminal device can read the corresponding system information blocks of multiple cells, which shortens the time for the terminal device to obtain resource information.

In another aspect, a method for sending control information is provided, including: carrying the control information in a header field or payload corresponding to a predetermined logical channel in user plane data; and sending the user plane data to a terminal device.

In another aspect, a network device for sending control information is provided, including: an information unit, configured to carry the control information in a header field or payload corresponding to a predetermined logical channel in user plane data; and a sending unit, configured to send the user plane data to a terminal device.

In this way, the embodiment of the present invention provides a new manner for carrying control information, that is, carrying control information in downlink user plane data, so that control information required to be sent to a terminal device can be carried without changing the existing data format.

### BRIEF DESCRIPTION OF DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a method for uplink access according to an embodiment of the present invention;

FIG. 2 is a schematic block diagram of a terminal device according to an embodiment of the present invention;

FIG. 3 is a schematic flowchart of a method for allocating terminal identifiers to a terminal device according to an embodiment of the present invention;

FIG. 4 is a schematic block diagram of a network device for allocating terminal identifiers to a terminal device according to an embodiment of the present invention;

FIG. 5 is a schematic flowchart of a method for broadcasting common enhanced dedicated channel resource information of multiple cells according to an embodiment of the present invention;

FIG. 6 is a schematic block diagram of a network device for broadcasting common enhanced dedicated channel resource information of multiple cells according to an embodiment of the present invention;

FIG. 7 is a schematic flowchart of a method for sending control information according to an embodiment of the present invention;

FIG. 8 is a schematic structural diagram of a PDU format of MAC-ehs;

FIG. 9 is a schematic block diagram of a network device for sending control information according to an embodiment of the present invention;

FIG. 10 is a schematic flowchart of a method 100 for uplink access according to an embodiment of the present invention; and

FIG. 11 is a schematic block diagram of a terminal device 110 according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

The technical solutions of the present invention may be applied to various communication systems, such as Global System for Mobile Communications (GSM), Code Division Multiple Access (CDMA, Code Division Multiple Access), Wideband Code Division Multiple Access (WCDMA, Wideband Code Division Multiple Access), General Packet Radio Service (GPRS, General Packet Radio Service), and Long Term Evolution (LTE, Long Term Evolution).

A mobile terminal (Mobile Terminal), or referred to as a user equipment (UE, User Equipment) or mobile user equipment, can communicate with one or more core networks via a radio access network (RAN, Radio Access Network). The mobile terminal may be a mobile phone (or referred to as “cellular” phone) or a computer equipped with a mobile terminal, and for example, may be a portable, pocket-sized, handheld, computer-embedded, or vehicle-mounted mobile apparatus, which exchanges voice and/or data with the radio access network.

A base station may be a base transceiver station in GSM or CDMA (BTS, Base Transceiver Station), or a base station in WCDMA (NodeB), or an evolved NodeB in LTE (eNB or e-NodeB, evolutional NodeB), which is not limited by the present invention. For ease of description, the NodeB will be used in the embodiments exemplarily.

It should be noted that, although the UE is used hereinafter to represent a terminal device, the NodeB (NodeB) is used to represent a base station, and the RNC is used to represent a radio network controller, the names will not limit the scope of the embodiments of the present invention. The embodiments of the present invention are not limited to any specific network radio access technology but can be applied to any multicarrier system.

When a UE has uplink data to send, a network cannot know this in advance, and therefore the UE needs to decide an access frequency by itself according to certain information.

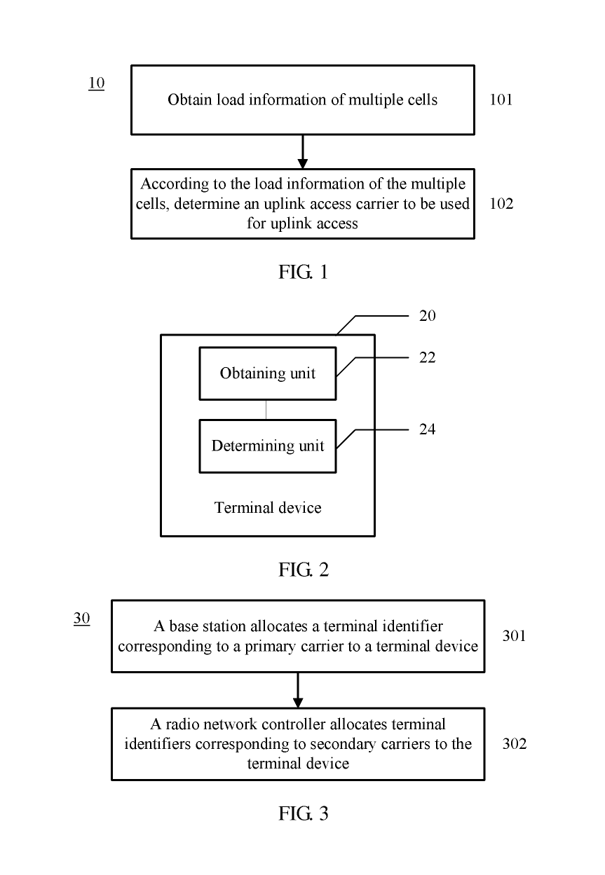

FIG. 1 is a schematic flowchart of a method 10 for uplink access according to an embodiment of the present invention. The method 10 is executed mainly by a terminal device.

As shown in FIG. 1, in step 101 of the method 10, a UE obtains load information of multiple cells. The load information is interference level values of the multiple cells or comparison relationship values of the interference level values. For example, the multiple cells may be the cells that the UE camps on, or inter-frequency neighboring cells of the camped cells with the same coverage, or neighboring cells which may be paired with the camped cells and a multicarrier operation mode.

According to an embodiment of the present invention, load information of multiple cells including a current cell and its neighboring cells can be obtained through broadcast of the current cell. Currently, the network broadcasts the interference level of a local cell in SIB7 (System Information Block type 7, system information block type 7). The broadcast content may be modified to broadcast in the current cell not only the interference level of the local cell but also the interference levels of neighboring cells where a multicarrier operation mode is possibly configured. In this way, the UE does not need to read SIB7 of multiple cells but only needs to read SIB7 of the current cell to obtain the load information of multiple cells including the current cell and its neighboring cells.

According to another embodiment of the present invention, the UE may read the system information blocks (SIBs) broadcast respectively in multiple cells and obtain load information from the system information blocks. For example, the UE may read the SIBs of the multiple cells periodically to obtain the interference levels.

The reading cycle of the above two manners may be decided by an expiry factor in SIB7 or specially configured by the network through signaling. In addition, when initially configuring a multicarrier operation or the cycle, the network may configure the interference levels of the cells or their comparison relationships for the UE, so that the UE can read earlier or initial interference levels or their comparison relationships from the broadcast.

According to another embodiment of the present invention, the UE may obtain load information carried by a network device through dedicated signaling or user plane data. The network may carry the interference levels of multiple cells or their comparison relationships through dedicated signaling by adding an IE (Information Element, information element) in the existing signaling.

The carrying load information through user plane data may be that the network device carries load information through a header or payload of MAC (Media Access Control, media access control) layer data. The specific carrying manners will be described in detail below.

In addition, in the embodiment of the present invention, when interference levels are carried, to reduce the amount of information or size of dedicated signaling broadcast in SIB7, the broadcast content may be only cell indexes and interference level values or only cell indexes and the sequence (comparison relationship values) of the interference level values. A mapping relationship between cell indexes and cells may be sent to the UE when a multicarrier operation mode is configured or may be broadcast in a SIB.

For example, if the range of cell index is 1-4 and the sequence broadcast in SIB7 is 3412 (ascending or descending order), 3412 may indicate the sequence of interference levels of the four cells indexed 1, 2, 3, and 4. As mentioned above, the information about which cells indexes 1, 2, 3, 4 stand for may be indicated to the UE through dedicated signaling or SIB5. Definitely, what is broadcast in SIB7 may also not be a sequence (comparison relationship values) but specific interference level values.

Then, in step 102, the UE determines, according to the load information of the multiple cells, an uplink access carrier to be used for uplink access. For example, during access, the UE compares the interference level values to select a proper access cell or selects a proper access cell directly according to the comparison relationship values of interference level values.

According to another embodiment of the present invention, the UE may determine, according to a terminal identifier and the quantity of available uplink access carriers, an uplink access carrier to be used for uplink access. Here, the terminal identifier may be an IMSI (International Mobile Subscriber Identification, international mobile subscriber identity), a TMSI (Temporary Mobile Subscriber Identity, temporary mobile subscriber identity), a URNTI (UTRAN Radio Network Temporary identity, UTRAN radio network temporary identity), an HRNTI (HS-DSCH RNTI, HS-DSCH radio network temporary identity), an E-RNTI (E-DCH RNTI, E-DCH radio network temporary identity) of the UE or other possible identifiers of the UE. The UE calculates an optimal access carrier according to the remainder of the terminal identifier mod (mod) the quantity of available uplink access carriers.

In this way, according to the embodiment of the present invention, when a terminal device initiates uplink access actively, the terminal device can select a proper uplink access carrier according to load information such as interference level values of cells or comparison relationship values of the interference level values, which solves the issue of carrier selection when a terminal triggers uplink access actively.

FIG. 2 is a schematic block diagram of a terminal device 20 according to an embodiment of the present invention. A non-limiting example of the terminal device 20 is the above described UE. As shown in FIG. 2, the terminal device 20 includes an obtaining unit 22 and a determining unit 24.

The obtaining unit 22 is configured to obtain load information of multiple cells, where the load information is interference level values of the multiple cells or comparison relationship values of the interference level values. The determining unit 24 is configured to determine, according to the load information of the multiple cells, an uplink access carrier to be used for uplink access.

The terminal device 20 can execute all steps of the method 10 shown in FIG. 1, which will not be repeated herein. For example, the obtaining unit 22 may obtain the load information of multiple cells including a current cell and its neighboring cells through broadcast of the current cell. Then, the broadcast content may be modified to broadcast in the current cell not only the interference level of the local cell but also the interference levels of neighboring cells where a multicarrier operation is possibly configured.

Alternatively, the obtaining unit 22 may read system information blocks (such as SIB7) broadcast respectively in multiple cells and obtain the load information from the system information blocks. In addition, the obtaining unit 22 may also obtain load information carried by a network device through dedicated signaling or user plane data, such as a newly-added IE or a header or payload of MAC layer data.

In this way, according to the embodiment of the present invention, when a terminal device initiates uplink access actively, the terminal device can select a proper uplink access carrier according to load information such as interference level values of cells or comparison relationship values of the interference level values, which solves the issue of carrier selection when a terminal triggers uplink access actively.

The available uplink carriers of the UE may include a primary carrier and secondary carriers corresponding respectively to different cells. First, terminal identifiers that correspond to different carriers, such as an E-RNTI, need to be allocated to the UE. Definitely, the UE may use the same E-RNTI in all carriers or the UE may allocate a different E-RNTI for each available uplink carrier.

Currently, E-RNTIs corresponding to the primary and secondary carriers of a CELL_DCH UE are all allocated by a NodeB. For a single-carrier CELL_FACH UE, the corresponding E-RNTI is also allocated by the NodeB during an initial connection setup process. For a multicarrier CELL_FACH UE, the NodeB allocates an E-RNTI corresponding to the uplink carrier (that is, the primary carrier) during an initial connection setup process. Then, an RNC (Radio Network Controller, radio network controller) designates secondary carriers according to the capability of the UE. If the E-RNTIs also need to be allocated to the secondary carriers, they can only be allocated by the NodeB according to referring technology.

However, as mentioned above, the E-RNTI allocation process is performed before the secondary carrier designation process. Therefore, it is apparent that the NodeB cannot allocate the E-RNTI of the primary carrier and the E-RNTIs of secondary carriers at the same time. In this case, if the manner similar to the process of allocating the E-RNTI of the primary carrier is repeated for the NodeB to allocate the E-RNTIs of the secondary carriers, allocation of terminal identifiers will be slowed down.

FIG. 3 is a schematic flowchart of a method 30 for allocating terminal identifiers to a terminal device according to an embodiment of the present invention. The terminal device is capable of selecting an uplink access carrier among multiple carriers including a primary carrier and secondary carries.

As shown in FIG. 3, in step 301 of the method 30, a base station (such as a NodeB) allocates a terminal identifier (such as the above E-RNTI) corresponding to a primary carrier to a terminal device (such as a UE). For example, the NodeB allocates the E-RNTI of the primary carrier during the initial connection setup process.

In step 302, a radio network controller (RNC) allocates terminal identifiers corresponding to secondary carriers to the terminal device. If the RNC allows the UE to select an uplink carrier dynamically, the RNC allocates E-RNTIs of secondary carriers when the RNC sets up multiple carriers (designates the secondary carriers) and notifies the UE by using a multicarrier configuration message. Then, when the RNC sends user data to the NodeB, the RNC also sends the allocated E-RNTIs of the secondary carriers to the NodeB.

According to an embodiment of the present invention, the RNC may allocate the terminal identifiers E-RNTIs corresponding to the secondary carriers and notify the UE and the NodeB of the allocated E-RNTIs of the secondary carriers, after receiving the terminal identifier corresponding to the primary carrier allocated by the NodeB and a terminal capability reported by the UE.

In addition, the RNC may allocate an E-RNTI to every secondary carrier or allocate E-RNTIs to only a part of the secondary carriers. For example, the RNC may only allow uplink access of the UE over a part of the secondary carriers according to the terminal capability and the service condition of the RNC. In this case, the RNC only allocates terminal identifiers corresponding to a part of secondary carriers that allow uplink access.

In this way, in the embodiment of the present invention, not only a base station is used to allocate a terminal identifier but also a radio network controller is allowed to allocate terminal identifiers corresponding to secondary carriers, which speeds up allocation of terminal identifiers.

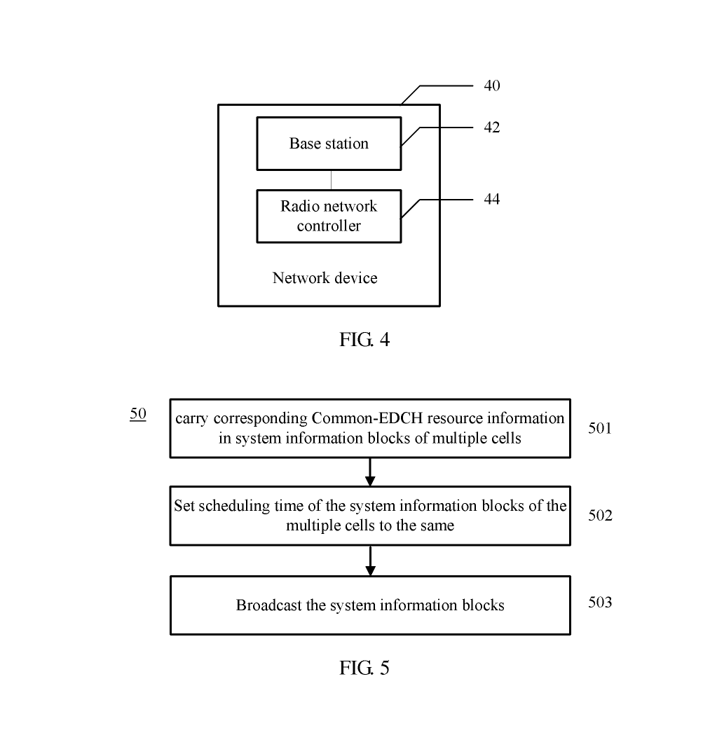

FIG. 4 is a schematic block diagram of a network device 40 for allocating terminal identifiers to a terminal device according to an embodiment of the present invention. The terminal device is capable of selecting an uplink access carrier among multiple carriers including a primary carrier and secondary carries.

As shown in FIG. 4, the network device 40 includes a base station 42 and a radio network controller 44. The base station 42 (such as a NodeB) is configured to allocate a terminal identifier corresponding to a primary carrier to a terminal device. The radio network controller 44 (such as an RNC) is configured to allocate terminal identifiers corresponding to secondary carriers to the terminal device.

The network device 40 can execute all steps of the method 30 shown in FIG. 3, which will not be repeated herein. For example, the RNC may allocate the terminal identifiers E-RNTIs corresponding to the secondary carriers and notify the UE and the NodeB of the allocated E-RNTIs of the secondary carriers, after receiving the terminal identifier corresponding to the primary carrier allocated by the NodeB and a terminal capability reported by the UE.

In addition, the RNC may allocate an E-RNTI to every secondary carrier or allocate E-RNTIs to only a part of the secondary carriers. For example, the RNC may only allow uplink access of the UE over a part of the secondary carriers according to the terminal capability and the service condition of the RNC. In this case, the RNC only allocates terminal identifiers corresponding to a part of secondary carriers that allow uplink access.

In this way, in the embodiment of the present invention, not only a base station is used to allocate a terminal identifier but also a radio network controller is allowed to allocate terminal identifiers corresponding to secondary carriers, which speeds up allocation of terminal identifiers.

After the E-RNTIs are allocated, the UE needs to obtain Common E-DCH (Common Enhanced Dedicated Channel, common enhanced dedicated channel) resource information of all available uplink carriers.

At present, Common-EDCH resources are broadcast in system information of a cell. The UE may obtain Common-EDCH resource information by reading the system information broadcast in the cell. When the UE is capable of performing uplink access in multiple cells (which means the UE has the capability of selecting an uplink carrier among multiple carriers), the UE needs to read Common-EDCH configuration information of the multiple cells. The Common-EDCH information of the multiple cells, however, may be scheduled at different time points and therefore it may take the UE a long time to obtain the Common-EDCH information of the multiple cells.

FIG. 5 is a schematic flowchart of a method 50 for broadcasting Common-EDCH resource information of multiple cells according to an embodiment of the present invention. As shown in FIG. 5, in step 501 of the method 50, corresponding common enhanced dedicated channel resource information is carried in system information blocks (such as SIB5) of multiple cells. In step 502, scheduling time of the system information blocks (SIB5) carrying common enhanced dedicated channel resource information of the multiple cells is set to the same. In this way, it is compulsory that the scheduling time for scheduling SIB5 between the cells that support a multicarrier operation is the same. Because the Common-EDCH information is carried in SIB5, if the scheduling of SIB5 is aligned, the UE can read the SIB5 of multiple cells at the same time, which shortens the time for the UE to obtain the Common-EDCH resources of multiple cells.

Then, in step 503, the system information blocks are broadcast. For example, the Common-EDCH information is sent to the UE through dedicated signaling.

In this way, in the embodiment of the present invention, system information blocks of multiple cells have the same scheduling time and therefore the scheduling of the system information blocks can be aligned, so that a terminal device can read the corresponding system information blocks of multiple cells at the same time, which shortens the time for the terminal device to obtain resource information.

According to another embodiment of the present invention, in a connection setup process or RB (Radio Bearer, radio bearer) setup/modification process of a UE, an RNC sends Common-EDCH information of secondary carriers of the UE to the UE through dedicated signaling, so that it is unnecessary for the UE to obtain the information through broadcast.

Correspondingly, the above different manners of sending Common-EDCH information may be applied to the UE side. That is, the UE side receives common enhanced dedicated channel resource information of multiple cells through cell broadcast of the multiple cells, where the time in the system information blocks in the cell broadcast of the multiple cells is set to the same. Alternatively, the UE may receive the common enhanced dedicated channel resource information of multiple cells through dedicated signaling.

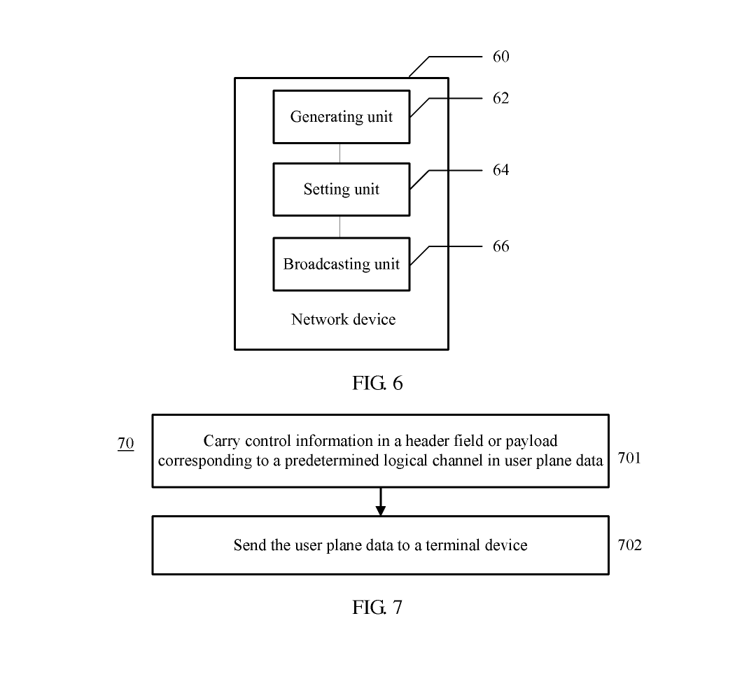

FIG. 6 is a schematic block diagram of a network device 60 for broadcasting common enhanced dedicated channel resource information of multiple cells according to an embodiment of the present invention. For example, the network device 60 may be a base station.

As shown in FIG. 6, the network device 60 includes a generating unit 62, a setting unit 64, and a broadcasting unit 66. The generating unit 62 is configured to carry corresponding common enhanced dedicated channel resource information in system information blocks of multiple cells; the setting unit 64 is configured to set scheduling time of the system information blocks carrying the common enhanced dedicated channel resource information of the multiple cells to the same; and the broadcasting unit 66 is configured to broadcast the system information blocks.

The network device 60 can execute all steps of the method 50 shown in FIG. 5, which will not be repeated herein. For example, the generating unit 62 may carry corresponding common enhanced dedicated channel resource information in a system information block SIB5.

In this way, in the embodiment of the present invention, corresponding system information blocks of multiple cells have the same scheduling time and therefore the scheduling of the system information blocks can be aligned, so that a terminal device can read the system information blocks of multiple cells at the same time, which shortens the time for the terminal device to obtain resource information.

In FIG. 1, that the UE independently selects the carrier used for uplink access is described. According to another embodiment of the present invention, the access carrier of the UE may also be designated by the network in advance.

FIG. 7 is a schematic flowchart of a method 70 for sending control information according to an embodiment of the present invention.

As shown in FIG. 7, in step 701 of the method 70, control information is carried in a header field or payload corresponding to a predetermined logical channel in user plane data (such as MAC data). Then, in step 702, the user plane data is sent to a terminal device.

For most services, uplink feedback is needed when downlink data is sent. When a network sends downlink data to a UE, it is possible that the UE initiates uplink access. Therefore, if the network needs to send downlink data to the UE, the uplink access resources available for the UE may be carried in the downlink data, including the carrier recommended for uplink access of the UE and/or the number of Common-EDCH resources used for access (if no carrier information is carried, the UE is instructed to perform access over the current primary carrier). The information may be carried in a header or payload data or in a combination of both.

According to an embodiment of the present invention, access carrier indication information may be carried in a MAC (media access control) layer header.

FIG. 8 is a schematic structural diagram of a PDU (Protocol Data Unit, protocol data unit) format of MAC-ehs. As shown in FIG. 8, the header takes a logical channel (LCH, Logical Channel) as a unit, and each logical channel identifier (LCH-ID) is sequentially followed by the length of a reordering unit (reordering PDU), the TSN (Transmission Sequence Number, transmission sequence number), an indication about whether SI (Scheduling Information, scheduling information) is carried, and whether a subsequent segmentation indication (F) exists, corresponding to the logical channel. In this case, a logical channel may be predetermined to carry the access carrier information. For example, the field L (length indication) of logical channel k (LCH-IDk in FIG. 8) is predefined to carry the access carrier indication information. In this case, logical channel k may not carry the TSN and the SI, or may not carry the corresponding reordering PDU. Both the UE and the NodeB know that the logical channel k indicates that the subsequent field L is not a specific length but indicates the access carrier and/or resource information. In this way, the indication of uplink access carrier information of the UE can be carried without changing the format of the MAC PDU. After receiving the PDU, the UE finds that the PDU carries logical channel k and deems that the content in the corresponding field L of the logical channel k indicates the access carrier indication information.

Alternatively, the indication information may be carried in a payload part of the PDU (such as the reordering PDU corresponding to logical channel k). Or, the above indication information is carried through the combination of a header and a payload.

In addition, because the NodeB may not know which data packets require uplink feedback, the RNC needs to carry an indication in the downlink frame protocol (FP) frame (Frame Protocol, Frame Protocol) to indicate whether the data packet requires uplink feedback (that is, whether the terminal device is required to execute uplink access).

In addition, the manner for sending control signaling through a special logical channel is not limited to sending the carrier information or access resource information for uplink access. It may also be applied to sending relevant control information such as carrier activation or deactivation. For example, the load information in the method 10 shown in FIG. 1, such as the interference level values of multiple cells or their comparison relationship values, may be carried in L field or reordering PDU.

In this way, the embodiment of the present invention provides a new manner for carrying control information, that is, carrying control information in downlink user plane data, so that control information required to be sent to a terminal device can be carried without changing the existing data format.

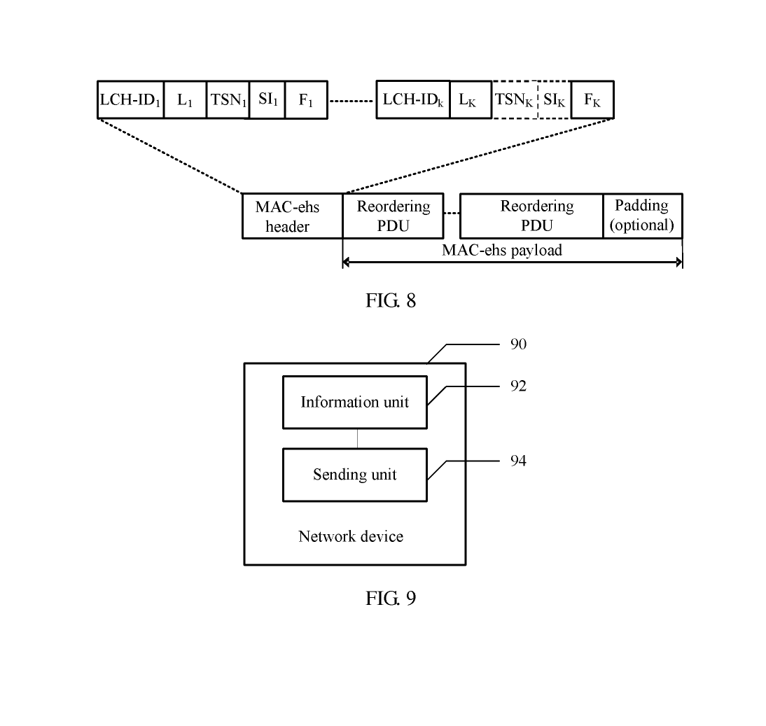

FIG. 9 is a schematic block diagram of a network device 90 for sending control information according to an embodiment of the present invention. For example, the network device 90 may be a base station. As shown in FIG. 9, the network device 90 includes an information unit 92 and a sending unit 94. The information unit 92 is configured to carry the control information in a header field or payload corresponding to a predetermined logical channel in user plane data (such as the MAC data). The sending unit 94 is configured to send the user plane data to a terminal device.

The network device 90 can execute all steps of the method 70 shown in FIG. 7, which will not be repeated herein. For example, the control information may include uplink access carrier information or access resource information for instructing the terminal device to execute uplink access. Alternatively, the control information may include carrier activation or deactivation information.

According to an embodiment of the present invention, as shown in FIG. 8, access carrier indication information may be carried in a MAC (media access control) layer header.

In this way, the embodiment of the present invention provides a new manner for carrying control information, that is, carrying control information in downlink user plane data, so that control information required to be sent to a terminal device can be carried without changing the existing data format.

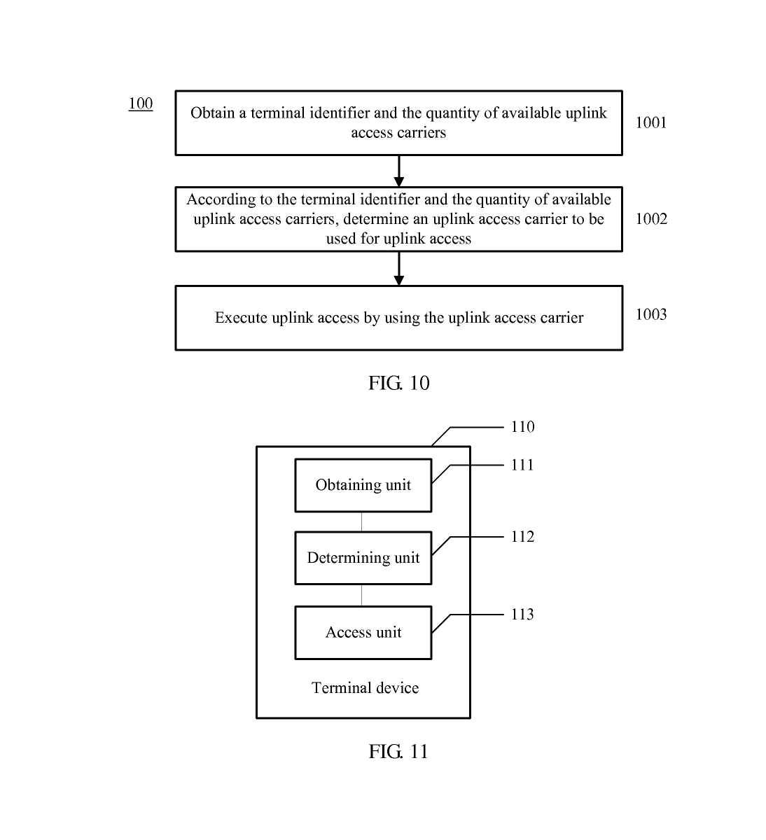

FIG. 10 is a schematic flowchart of a method 100 for uplink access according to an embodiment of the present invention. The method 100 includes the following.

1001. Obtain a terminal identifier and the quantity of available uplink access carriers.

For example, the allocated terminal identifier may be obtained according to the method shown in FIG. 3. The embodiment of the present invention, however, is not limited thereto. The terminal identifier may be an IMSI, a TMSI, a URNTI, an HRNTI or an E-RNTI of the UE, or other possible identifiers of the UE.

1002. According to the terminal identifier and the quantity of available uplink access carriers, determine an uplink access carrier to be used for uplink access.

For example, the terminal identifier may be divided by the quantity of available uplink access carriers to obtain a remainder, and an optimal uplink access carrier may be determined according to the remainder. For example, the uplink access carrier whose index is the remainder may be selected.

1003. Execute uplink access by using the uplink access carrier.

In this way, in the embodiment of the present invention, a terminal device can select an uplink access carrier to be used for uplink access from available uplink access carriers according to a terminal identifier and the quantity of the available uplink access carriers, which solves the issue of carrier selection when a terminal triggers uplink access actively.

FIG. 11 is a schematic block diagram of a terminal device 110 according to an embodiment of the present invention. The terminal device 110 includes: an obtaining unit 111, configured to obtain a terminal identifier and the quantity of available uplink access carriers; a determining unit 112, configured to determine, according to the terminal identifier and the quantity of available uplink access carriers, an uplink access carrier to be used for uplink access; and an access unit 113, configured to execute uplink access by using the uplink access carrier.

The parts of the terminal device 110 can respectively execute the steps of the method 100 shown in FIG. 10, which will not be repeated herein. For example, the determining unit 112 may divide the terminal identifier by the quantity of available uplink access carriers to obtain a remainder, and determine an optimal uplink access carrier according to the remainder. For example, the uplink access carrier whose index is the remainder may be selected.

In this way, in the embodiment of the present invention, a terminal device can select an uplink access carrier to be used for uplink access from available uplink access carriers according to a terminal identifier and the quantity of the available uplink access carriers, which solves the issue of carrier selection when a terminal triggers uplink access actively.

It may be clearly understood by a person skilled in the art that, for the purpose of convenient and brief description, for a detailed working process of the foregoing system, apparatus, and unit, reference may be made to the corresponding process in the foregoing method embodiments, and details will not be described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the illustrated or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on a plurality of network elements. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in the form of hardware, or may be implemented in the form of a software functional unit. Those skilled in the art may appreciate that the exemplary units and steps described in the embodiments disclosed herein can be implemented through electronic hardware, or computer software, or a combination of both. To better explain the interchangeability between hardware and software, the composition and steps in the embodiments have been generally described according to the functions. Whether these functions are executed by hardware or software depends on the specific application and design constraints of the technical solutions. A person skilled in the art can implement the functions by using different methods specific to each application but it should not be considered that the implementation falls beyond the scope of the present invention.

The integrated unit can be stored in a computer readable storage medium when it is implemented in the form of a software functional unit and sold or used as an independent product. Based on such an understanding, the technical solutions of the present invention essentially, or the part contributing to the prior art, or part of the technical solutions may be implemented in the form of a software product. The computer software product is stored in a storage medium, and includes several instructions for instructing a computer device (which may be a personal computer, a server, or a network device) to perform all or a part of the steps of the method described in the embodiments of the present invention. The storage medium includes any medium that can store program codes, such as a USB flash disk, a removable hard disk, a read-only memory (ROM, Read-Only Memory), a random access memory (RAM, Random Access Memory), a magnetic disk, or an optical disk.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for uplink access, comprising:
obtaining load information of multiple cells, wherein the load information comprises one of interference level values of the multiple cells and comparison relationship values of interference level values; and
determining, according to the load information of the multiple cells, an uplink access carrier to be used for uplink access.

2. The method according to claim 1, wherein the obtaining the load information of the multiple cells comprises:
obtaining the load information of the multiple cells comprising a current cell and neighboring cells through broadcast of the current cell.

3. The method according to claim 1, wherein the obtaining the load information of the multiple cells comprises:
reading system information blocks broadcast respectively by the multiple cells; and
obtaining the load information from the system information blocks.

4. The method according to claim 1, wherein the obtaining the load information of the multiple cells comprises:
obtaining the load information from a network device through dedicated signaling or user plane data.

5. The method according to claim 4, wherein the obtaining the load information carried by the network device through the user plane data comprises:
obtaining the load information carried by the network device through a header or payload of media access control MAC layer data.

6. The method according to claim 1, further comprising:
receiving common enhanced dedicated channel resource information of the multiple cells through dedicated signaling.

7. A terminal device, comprising:
a first processor, configured to obtain load information of multiple cells, wherein the load information comprises one of interference level values of the multiple cells and comparison relationship values of the interference level values; and
a second processor, configured to determine, according to the load information of the multiple cells, an uplink access carrier to be used for uplink access.

8. The terminal device according to claim 7, wherein the first processor is specially configured to obtain the load information of the multiple cells comprising a current cell and neighboring cells through broadcast of the current cell.

9. The terminal device according to claim 7, wherein the first processor is specially configured to read system information blocks broadcast respectively by the multiple cells and obtain the load information from the system information blocks.

10. The terminal device according to claim 7, wherein the first processor is specially configured to obtain the load information from a network device through dedicated signaling or user plane data.
